(19) United States
(12) Patent Application Publication
(10) Pub. No.: US 2026/0118208 A1
(43) Pub. Date: Apr. 30, 2026

(54) QUANTITATIVE EVALUATION METHOD AND SYSTEM FOR LEAKAGE RATE OF SALT CAVERN HELIUM GAS STORAGE IN GAS INJECTION CONSTRUCTION PERIOD

(71) Applicant: INSTITUTE OF ROCK AND SOIL MECHANICS, CHINESE ACADEMY OF SCIENCES, Wuhan (CN)

(72) Inventors: Tongtao Wang, Wuhan (CN); Youqiang Liao, Wuhan (CN); Chunhe Yang, Wuhan (CN); Tao He, Wuhan (CN); Dongzhou Xie, Wuhan (CN); Hongling Ma, Wuhan (CN); Xilin Shi, Wuhan (CN); Guangtan Huang, Wuhan (CN); Zhekang Ding, Wuhan (CN)

(73) Assignee: INSTITUTE OF ROCK AND SOIL MECHANICS, CHINESE ACADEMY OF SCIENCES, Wuhan (CN)

(21) Appl. No.: 19/357,278

(22) Filed: Oct. 14, 2025

(30) Foreign Application Priority Data
Oct. 25, 2024 (CN) 2024115007685

(51) Int. Cl. G01M 3/26; G01M 3/36; G06F 30/28; G06F 113/08

(52) U.S. Cl. CPC G01M 3/26; G01M 3/36; G06F 30/28; G06F 2113/08

(57) ABSTRACT

A quantitative evaluation method and system for a leakage rate of a salt cavern helium gas storage in a gas injection construction period are provided. The method includes the following steps: S1, acquiring basic data of the salt cavern helium gas storage; S2, monitoring and recording wellhead pressure, gas injection flow rate, and gas injection temperature data in real time in the gas injection construction period; and S3, performing numerical simulation on a temperature field of helium gas in the storage, a creep law of a cavity, and a dissolving trend of the helium gas by using the basic data of the salt cavern helium gas storage and the real-time monitored data, to achieve quantitative evaluation of the leakage rate.

### CROSS-REFERENCE TO RELATED APPLICATIONS

This application claims priority to Chinese Patent Application Ser. No. CN2024115007685 filed on 25 Oct. 2025.

### FIELD OF THE INVENTION

The present application relates to the technical field of underground storages for helium gas and other rare gases, and in particular to, a quantitative evaluation method and system for a leakage rate of a salt cavern helium gas storage in a gas injection construction period.

### BACKGROUND OF THE INVENTION

Helium gas, as a strategically scarce substance, is widely used as a pressurizing agent and propellant for liquid fuel of rockets, a coolant in the nuclear industry, and leak detection for pipelines and electronic and electrical devices. Salt rock formations are excellent geological bodies for deep underground energy storage, and have the characteristics of low permeability (less than 10⁻²⁰ m²) and low porosity (less than 1%). Existing research has demonstrated the technical feasibility of helium gas storage in the salt rock formations.

In the existing technology, nitrogen gas is commonly used for gas tightness testing during the construction of a salt cavern natural gas storage. However, compared with the nitrogen gas, helium gas has smaller molecules. Under the same operating pressure, the helium gas has high permeation and diffusion loss. The gas tightness of the nitrogen gas cannot be completely equivalent to that of the helium gas. Meanwhile, the market price of the helium gas ranges from 100 to 500 yuan/standard cubic meter, which is far higher than the price of natural gas. Even a small leakage can cause substantial economic loss to an owner. Therefore, an acceptable leakage threshold for the natural gas storage is obviously no longer appropriate in a helium gas storage. However, the current methods for evaluating leakage rate still rely on traditional evaluation methods for the natural gas storage, which focuses on feasibility evaluation in an initial construction period and leakage amount prediction in an operating period. The methods are evidently unsuitable for a helium gas storage with a higher accuracy requirement and particularly unsuitable in a gas injection construction period, and no relevant patents addressing the issue have been published to date. At present, there is no technology that uses helium gas for gas tightness testing during the construction of the salt cavern natural gas storage. Therefore, it is an urgent need for a quantitative evaluation method for a leakage rate of a salt cavern helium gas storage in a gas injection construction period, which can enable early diagnosis of potential leak locations, prompt implementation of mitigation measures, and reduce helium loss and operational risks.

### SUMMARY OF THE INVENTION

To solve the above problems, the present application provides a quantitative evaluation method and system for a leakage rate of a salt cavern helium gas storage in a gas injection construction period, which achieves feasibility evaluation in an initial construction period of helium gas with a high-accuracy requirement and leakage amount prediction in an operating period, and meets major demands for prediction of a helium gas leakage rate of the salt cavern helium gas storage in the construction period.

The present application provides a quantitative evaluation method for a leakage rate of a salt cavern helium gas storage in a gas injection construction period, comprising a non-transitory computer readable medium operable on a computer with memory for the quantitative evaluation method, and comprising program instructions for executing the following steps of:
S1, acquiring basic data of the salt cavern helium gas storage;
S2, monitoring and recording wellhead pressure, gas injection flow rate, and gas injection temperature data in real time in the gas injection construction period;
S3, performing numerical simulation on a temperature field of helium gas in the storage, a creep behaviors of a cavity, and a dissolving trend of the helium gas by using the basic data of the salt cavern helium gas storage and the real-time monitored data, to achieve quantitative evaluation of the leakage rate; and
S4, based on the results of quantitative assessment methods, achieve early diagnosis of potential leakage locations, and rapidly implement mitigation measures, thereby maintaining the structural integrity of the cavity, reducing helium loss, and minimizing operational risks.

For example, in the quantitative evaluation method for the leakage rate of the salt cavern helium gas storage in the gas injection construction period according to an embodiment, in S3, the quantitative evaluation of the helium gas leakage rate includes calculating a leakage amount of the helium gas; and a calculation method for the leakage amount of the helium gas is:

$${n}_{L} = {n}_{0} - {n}_{k} - {n}_{r} ; \qquad Formula ( 1 )$$

in Formula (1), n_{L} represents the leakage amount of the helium gas; no represents an accumulative injection amount of the helium gas; nᵣ represents a dissolved quantity of the helium gas; and nₖ represents a storage amount of the helium gas in the current cavity.

For example, in the quantitative evaluation method for the leakage rate of the salt cavern helium gas storage in the gas injection construction period according to an embodiment, a calculation method for the storage amount nₖ of the helium gas in the current cavity is:

$${n}_{k} = \int {\int }_{V} \int \frac{p ( V + Δ V )}{{ZRT}_{f}} dV ; \qquad Formula ( 2 )$$

in Formula (2), V represents a volume of a salt cavern cavity; ΔV represents an actually measured volume shrinkage; T_{f} represents a temperature of the helium gas; P represents a pressure of the helium gas; Z represents a compression factor of the helium gas; R represents a gas constant; and
by combining Formula (1) and Formula (2), the helium gas leakage rate can be calculated.

For example, in the quantitative evaluation method for the leakage rate of the salt cavern helium gas storage in the gas injection construction period according to an embodiment, in S3, the numerical simulation of the dissolving trend of the helium gas is to predict a dissolved quantity of the helium gas, and diffusion dissolution of the helium gas in brine is obtained according to a diffusion law, which satisfies the following formula:

$$\frac{\partial c}{\partial t} + ∇ \cdot ( - D ∇ c ) = 0 ; \qquad Formula ( 3 )$$

in Formula (3), c represents a concentration of the helium gas in the brine; D represents a diffusion coefficient of the helium gas in the brine;
based on Formula (3), concentration distributions of the helium gas in the brine at different moments can be simulated; and the dissolved quantity nᵣ of the helium gas is calculated by volume integration using the following formula:

$${n}_{r} = \int {\int }_{V} \int cdV . \qquad Formula ( 4 )$$

For example, in the quantitative evaluation method for the leakage rate of the salt cavern helium gas storage in the gas injection construction period according to an embodiment, the creep law of the cavity in S3 is to predict the volume shrinkage of the salt cavern helium gas storage, and a calculation method is:

$${\int }_{0}^{t} {ae}^{- x} dt = \frac{Δ V}{V} ; \qquad Formula ( 5 )$$

in Formula (5), V represents the volume of the salt cavern cavity; 4V represents the actually measured volume shrinkage; X represents a creep rate attenuation index, which is obtained through a core creep test on a target layer of the helium gas storage; and a represents an empirical coefficient, which is obtained by inverting the actually measured volume shrinkage of the cavity.

For example, in the quantitative evaluation method for the leakage rate of the salt cavern helium gas storage in the gas injection construction period according to an embodiment, in S3, a method for predicting the temperature field of the helium gas is as follows:

$$A ρ {C}_{V , g} \frac{\partial {T}_{f}}{\partial t} - A ( {ρμ}_{jT} {C}_{V , g} + 1 ) \frac{\partial p}{\partial t} = {Q}_{e} ; \qquad Formula ( 6 )$$

in Formula (6), A represents a cross-sectional area of a wellbore or a salt cavern; ρ represents a density of the helium gas; C_{v,g} represents a specific heat capacity of the helium gas; T_{f} represents the temperature of the helium gas; t represents time; μ_{jT} represents the Joule-Thomson coefficient of the helium gas; p represents a pressure of the helium gas; Qₑ represents a convective heat transfer rate between the helium gas and surrounding rock; a calculation method for Qₑ is:

$${Q}_{e} = 2 π {r}_{0} {U}_{we} ( {T}_{e} - {T}_{f} ) ; \qquad Formula ( 7 )$$

in Formula (7), r₀ represents a radius of the wellbore or salt cavern; U_{we} represents a comprehensive heat transfer coefficient between the gas and a surrounding environment; Tₑ represents a formation temperature; a calculation method for Tₑ is:

$${ρ}_{e} {C}_{e} \frac{\partial {T}_{e}}{\partial t} = \frac{1}{r} \frac{\partial }{\partial r} ( {k}_{e} r \frac{\partial {T}_{e}}{\partial r} ) ; \qquad Formula ( 8 )$$

in Formula (8), r represents a distance from a center of the gas storage; ρₑ represents a density of formation rock; Cₑ represents a specific heat capacity of geological rock; Kₑ represents a thermal conductivity coefficient of the formation rock;
a calculation method for the comprehensive heat transfer coefficient U_{we} between the gas and the surrounding environment is:

$${U}_{we}^{- 1} = \frac{1}{{h}_{t}} + \frac{{r}_{to} ln ( {r}_{co} / {r}_{ci} )}{{k}_{cas}} + \frac{{r}_{to} ln ( {r}_{ces} / {r}_{co} )}{{k}_{ces}} ; \qquad Formula ( 9 )$$

in Formula (9), hₜ represents a heat transfer coefficient of the helium gas; rₜₒ, r_{co}, r_{ci}, and r_{ces} represent an outer diameter of an injection and production pipe, inner and outer diameters of a casing, and an outer diameter of a cement sheath, respectively; k_{cas} and k_{ces} are thermal conductivity coefficients of the casing and the cement sheath; and
by combining Formula (6) to Formula (9), temperature changes of the helium gas in the cavity over time in the gas injection construction period are calculated.

A second aspect of the present application provides a quantitative evaluation system for a leakage rate of a salt cavern helium gas storage in a gas injection construction period, including:

a basic data acquisition unit, configured to: acquire basic data of the salt cavern helium gas storage;
a real-time monitoring unit, configured to monitor and record wellhead pressure, gas injection flow rate, and gas injection temperature data in real time in the gas injection construction period; and
a leakage rate quantitative evaluation unit, configured to: perform numerical simulation on a temperature field of helium gas in the storage, a creep law of a cavity, and a dissolving trend of the helium gas by using the basic data of the salt cavern helium gas storage and the real-time monitored data, and perform quantitative evaluation on the leakage rate of the salt cavern helium gas storage according to actually measured wellhead pressure data.

For example, in the quantitative evaluation system for the leakage rate of the salt cavern helium gas storage in the gas injection construction period according to an embodiment, the basic data acquired by the basic data acquisition unit is basic data used for quantitative evaluation on the leakage rate of the salt cavern helium gas storage, and includes sonar cavity data of the salt cavern cavity, a well trajectory, a well bore structure, and a size of a gas injection pipe.

For example, in the quantitative evaluation system for the leakage rate of the salt cavern helium gas storage in the gas injection construction period according to an embodiment, the real-time monitoring unit includes a gas flow meter, a gas thermometer, and a wellhead pressure gauge which are arranged on a ground injection and production manifold to monitor and store a wellhead pressure, a gas injection flow rate, and a gas injection temperature in real time.

For example, in the quantitative evaluation system for the leakage rate of the salt cavern helium gas storage in the gas injection construction period according to an embodiment, the data monitored and recorded by the real-time monitoring unit is transmitted to a data receiver through Bluetooth, and the actually measured data is transmitted through the data receiver to the leakage rate quantitative evaluation unit for quantitative evaluation of a leakage rate.

The quantitative evaluation method and system for the leakage rate of the salt cavern helium gas storage in the gas injection construction period according to some embodiments of the present application have beneficial effects below: By accurately predicting four factors, i.e., the helium gas leakage, the helium gas dissolution, a heating effect of the gas, and the cavity contraction, real-time back-calculation of a leakage rate of helium gas is achieved and feasibility evaluation in an initial construction period of helium gas with a high accuracy requirement and leakage amount prediction in an operating period are achieved. The evaluation method of the present application is supported by a comprehensive theoretical model and is effectively integrated with the real-time data monitored on the site. The evaluation method is simple in calculation, scientific, and appropriate, meets major demands for prediction of a helium gas leakage rate in the construction period and can provide a technical support for an optimal design of a surface injection and production process of the salt cavern helium gas storage.

### BRIEF DESCRIPTION OF THE DRAWINGS

To describe the technical solutions in the embodiments of this specification or in the prior art more clearly, the following will briefly introduce the accompanying drawings needing to be used in the embodiments. Apparently, the accompanying drawings in the following description show merely some embodiments of the present application, and a person of ordinary skill in the art may still derive other drawings from the accompanying drawings without creative efforts.

FIG. 1 is a schematic structural diagram of a quantitative evaluation system for a leakage rate of a salt cavern helium gas storage in a gas injection construction period according to the present application; and

FIG. 2 is a flowchart of a quantitative evaluation method for a leakage rate of a salt cavern helium gas storage in a gas injection construction period according to the present application.

### DETAILED DESCRIPTION OF THE EMBODIMENTS

The technical solutions in embodiments of the present disclosure are clearly and completely described in the following with reference to the accompanying drawings in the embodiments of the present disclosure. Apparently, the described embodiments are merely some rather than all the embodiments of the present disclosure. All other embodiments obtained by a person of ordinary skill in the art based on the embodiments of the present application without making creative efforts shall fall within the protection scope of the present application.

Unless otherwise defined, technical or scientific terms used in the present application should have the ordinary meanings as understood by those of ordinary skill in the art to which the present application belongs. The terms “first”, “second”, and the like used in the present application do not indicate any order, quantity, or importance, but are only used to distinguish different components. The term “include”, “contain”, or another other similar term means that the elements or objects stated before them encompass the elements or objects and equivalents thereof listed after them, but do not exclude other elements or objects. The term such as “connect” or “connection” is not limited to physical or mechanical connection, but can include electrical connection, whether direct or indirect. The terms “upper”, “lower”, “left”, “right”, and the like are merely used to indicate relative positional relationships. After the absolute position of a described object changes, the relative positional relationship may also change accordingly.

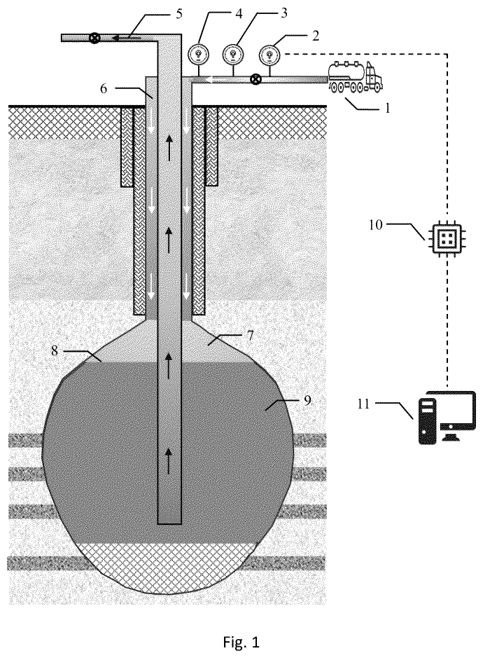

As shown in FIG. 1, during gas injection construction of a salt cavern helium gas storage, a gas injection pipe 6 serves as a connecting channel between a helium gas tank truck 1 and a helium storage cavity 7. High-pressure helium gas is injected into the helium storage cavity 7 through the gas injection pipe 6 by the helium gas tank truck 1, and presses brine 9 inside the cavity, and the brine is discharged through a brine discharge pipe 5. After the helium gas is injected into the salt cavern, a change in a wellhead pressure is mainly affected by four factors: helium gas leakage, helium gas dissolution, changes in a temperature of the helium gas, and cavity contraction. If the helium gas dissolution, helium gas temperature recovery, and the cavity contraction can be accurately predicted, a leakage rate of the helium gas can be back-calculated in real time.

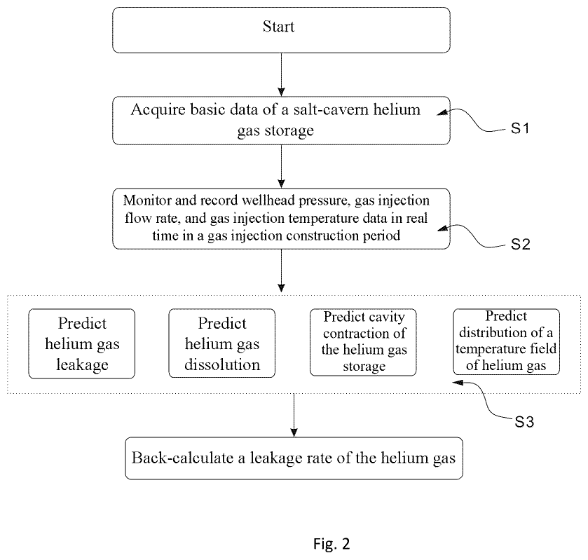

In view of this, the present application provides a quantitative evaluation method for a leakage rate of a salt cavern helium gas storage in a gas injection construction period, as shown in FIG. 2, comprising a non-transitory computer readable medium operable on a computer with memory for the quantitative evaluation method, and comprising program instructions for executing the following steps of:
S1, acquiring basic data of the salt cavern helium gas storage;
specifically, including acquisition of a sonar cavity form, a well bore structure, a well trajectory, a size of an injection and production pipe, and other basic information of the salt cavern helium gas storage;
S2, monitoring and recording wellhead pressure, gas injection flow rate, and gas injection temperature data in real time in the gas injection construction; and
S3, performing numerical simulation on a temperature field of helium gas in the storage, a creep law of a cavity, and a dissolving trend of the helium gas by using the basic data of the salt cavern helium gas storage and the real-time monitored data, to achieve quantitative evaluation of the leakage rate.

Compared with a traditional evaluation method for a leakage rate of a salt cavern natural gas storage, the quantitative evaluation method for the leakage rate of the salt cavern helium gas storage in the gas injection construction period according to the present application can provide a technical measure for fine evaluation of the leakage rate of the salt cavern helium gas storage in the gas injection construction period of the salt cavern helium gas storage. The evaluation method of the present application is supported by a comprehensive theoretical model and is effectively integrated with the real-time data monitored on the site, and is simple in calculation, scientific, and appropriate.

For example, in the quantitative evaluation method for the leakage rate of the salt cavern helium gas storage in the gas injection construction period according to an embodiment, in S3, the quantitative evaluation of the helium gas leakage rate includes calculating a leakage amount of the helium gas. According to the principle of mass conservation, the leakage amount of the helium gas is equal to a value of an amount of the helium gas injected into the cavity minus a dissolved quantity of the helium gas minus a storage amount of the helium gas in the current cavity, and an expression is as follows:

$${n}_{L} = {n}_{0} - {n}_{k} - {n}_{r} ; \qquad Formula ( 1 )$$

in Formula (1), n_{L} represents the leakage amount of the helium gas; no represents an accumulative injection amount of the helium gas; nᵣ represents a dissolved quantity of the helium gas; and nₖ represents a storage amount of the helium gas in the current cavity.

A calculation method for the storage amount nₖ of the helium gas in the current cavity is:

$${n}_{k} = \int {\int }_{V} \int \frac{p ( V + Δ V )}{{ZRT}_{f}} dV ; \qquad Formula ( 2 )$$

in Formula (2), V represents a volume of a salt cavern cavity; ΔV represents an actually measured volume shrinkage; T_{f} represents a temperature of the helium gas; P represents a pressure of the helium gas; Z represents a compression factor of the helium gas; R represents a gas constant; and by combining Formula (1) and Formula (2), the helium gas leakage rate is calculated.

Dissolution of the helium gas in the brine is a diffusion dissolution process. A helium gas concentration at a gas-brine interface 8 tends to be saturated. For example, in the quantitative evaluation method for the leakage rate of the salt cavern helium gas storage in the gas injection construction period according to an embodiment, in S3, the numerical simulation of the dissolving trend of the helium gas is to predict a dissolved quantity of the helium gas, and diffusion dissolution of the helium gas in brine is obtained according to a diffusion law, which satisfies the following formula:

$$\frac{\partial c}{\partial t} + ∇ \cdot ( - D ∇ c ) = 0 ; \qquad Formula ( 3 )$$

in Formula (3), c represents a concentration of the helium gas in the brine; D represents a diffusion coefficient of the helium gas in the brine;
based on Formula (3), concentration distributions of the helium gas in the brine at different moments can be simulated; and the dissolved quantity nᵣ of the helium gas is calculated by volume integration using the following formula:

$${n}_{r} = \int {\int }_{V} \int cdV . \qquad Formula ( 4 )$$

Since an operating pressure of the salt cavern helium gas storage is less than an in-situ ground stress of a formation, surrounding rock of the helium gas storage may inevitably contract, causing a decrease in the volume of the cavity. The decrease in the volume of the cavity may press the helium gas, leading to an increase in the wellhead pressure. Although there are individual differences between salt caverns, the volume shrinkage rates of the salt cavern storages in the same district are substantially the same. Therefore, the volume shrinkage rate of the helium gas storage can be predicted using historical volume shrinkage data of other salt cavern helium gas storages that have been put into use. For example, in the quantitative evaluation method for the leakage rate of the salt cavern helium gas storage in the gas injection construction period according to an embodiment, the creep law of the cavity in S3 is to predict the volume shrinkage of the salt cavern helium gas storage, and a calculation method is:

$${\int }_{0}^{t} {ae}^{- x} dt = \frac{Δ V}{V} ; \qquad Formula ( 5 )$$

in Formula (5), V represents the volume of the salt cavern cavity; ΔV represents the actually measured volume shrinkage; X represents a creep rate attenuation index, which is obtained through a core creep test on a target layer of the helium gas storage; and a represents an empirical coefficient, which is obtained by inverting the actually measured volume shrinkage of the cavity. After the creep rate attenuation index X and the empirical coefficient a are determined, the volume shrinkage AV of the cavity at any time can be predicted.

In a closed storage space, a heat transfer method between the helium gas and salt cavern surrounding rock, as well as a wellbore, is heat conduction. For example, in the quantitative evaluation method for the leakage rate of the salt cavern helium gas storage in the gas injection construction period according to an embodiment, in S3, a method for predicting the temperature field of the helium gas is as follows:

$$A ρ {C}_{V , g} \frac{\partial {T}_{f}}{\partial t} - A ( ρ {μ}_{jT} {C}_{V , g} + 1 ) \frac{\partial p}{\partial t} = {Q}_{e} ; \qquad Formula ( 6 )$$

in Formula (6), A represents a cross-sectional area of a wellbore or a salt cavern; ρ represents a density of the helium gas; C_{v,g} represents a specific heat capacity of the helium gas; T_{f} represents the temperature of the helium gas; t represents time; μ_{jT} represents the Joule Thomson coefficient of the helium gas; p represents a pressure of the helium gas; Qₑ represents a convective heat transfer rate between the helium gas and surrounding rock, which is the root cause of an increase in the temperature of the helium gas; a calculation method for Qₑ is:

$${Q}_{e} = 2 π {r}_{0} {U}_{we} ( {T}_{e} - {T}_{f} ) ; \qquad Formula ( 7 )$$

in Formula (7), r₀ represents a radius of the wellbore or salt cavern; U_{we} represents a comprehensive heat transfer coefficient between the gas and a surrounding environment; Tₑ represents a formation temperature; a calculation method for Tₑ is:

$${ρ}_{e} {C}_{e} \frac{\partial {T}_{e}}{\partial t} = \frac{1}{r} \frac{\partial }{\partial r} ( {k}_{e} r \frac{\partial {T}_{e}}{\partial r} ) ; \qquad Formula ( 8 )$$

in Formula (8), r represents a distance from a center of the gas storage; ρₑ represents a density of formation rock; Cₑ represents a specific heat capacity of geological rock; Kₑ represents a thermal conductivity coefficient of the formation rock.

The comprehensive heat transfer coefficient U_{we} between the gas and the surrounding environment is related to structures and thermophysical property parameters of a casing and a cement sheath, and a calculation method is:

$${U}_{we}^{- 1} = \frac{1}{{h}_{t}} + \frac{{r}_{to} ln ( {r}_{co} / {r}_{ci} )}{{k}_{cas}} + \frac{{r}_{to} ln ( {r}_{ces} / {r}_{co} )}{{k}_{ces}} ; \qquad Formula ( 9 )$$

in Formula (9), hₜ represents a heat transfer coefficient of the helium gas; rₜₒ, r_{co}, r_{ci}, and r_{ces} represent an outer diameter of an injection and production pipe, inner and outer diameters of a casing, and an outer diameter of a cement sheath, respectively; k_{cas} and k_{ces} are thermal conductivity coefficients of the casing and the cement sheath; and
by combining Formula (6) to Formula (9), temperature changes of the helium gas in the cavity over time in the gas injection construction period are calculated.

In summary, the helium gas leakage rate can be calculated.

According to the quantitative evaluation method for the leakage rate of the salt cavern helium gas storage in the gas injection construction period of the present application, numerical simulation is performed on the helium gas leakage, the helium dissolution, the changes in the temperature of the helium gas, and the cavity contraction by using the basic data of the salt cavern helium gas storage and the real-time monitored data. The impact of the above four effects on the wellhead pressure is quantitatively represented to back-calculate the leakage rate of the helium gas in real time.

A second aspect of the present application provides a quantitative evaluation system for a leakage rate of a salt cavern helium gas storage in a gas injection construction period, as shown in FIG. 1, including:
a basic data acquisition unit, configured to: acquire basic data of the salt cavern helium gas storage;
a real-time monitoring unit, configured to monitor and record wellhead pressure, gas injection flow rate, and gas injection temperature data in real time in the gas injection construction period, and including a gas flow meter 2, a gas thermometer 3, a wellhead pressure gauge 4, and a data receiver 10, to monitor and store a wellhead pressure, a gas injection flow, and a gas injection temperature in real time, where specifically, the gas flow meter 2, the gas thermometer 3, and the wellhead pressure gauge 4 are mounted on a ground injection and production manifold of a gas injection pipe 6, and the actually measured data is transmitted to the data receiver 10 through Bluetooth and to a leakage rate quantitative evaluation unit 11 for quantitative evaluation of a leakage rate; and
the leakage rate quantitative evaluation unit 11, configured to: perform numerical simulation on a temperature field of helium gas in the storage, a creep law of a cavity, and a dissolving trend of the helium gas by using the basic data of the salt cavern helium gas storage and the real-time monitored data, and perform quantitative evaluation on the leakage rate of the salt cavern helium gas storage according to actually measured wellhead pressure data.

According to the quantitative evaluation system for the leakage rate of the salt cavern helium gas storage in the gas injection construction period of the present application, the leakage rate of the helium gas is finally back-calculated by monitoring and storing a wellhead pressure, a gas injection flow, and a gas injection temperature in real time through the real-time monitoring unit and performing quantitative simulation on the four effects, i.e., the helium gas leakage, the helium gas dissolution, the change in the temperature of the helium gas, and the cavity contraction through the leakage rate quantitative evaluation unit 11.

Compared with a traditional technical means, the quantitative evaluation method and system for the leakage rate of the salt cavern helium gas storage in the gas injection construction period according to the present application has the advantages that the method is supported by a comprehensive theoretical model and is effectively integrated with the real-time data monitored on the site, is simple in calculation, scientific, and appropriate, meets major demands for prediction of a helium gas leakage rate in the construction period, and can provide a technical support for an optimal design of a surface injection and production process of the salt cavern helium gas storage.

Although the implementation solutions of the present application have been disclosed above, it is not limited to the applications listed in this specification and the implementations. The implementation solutions can be fully applied to various fields suitable for the present application. For those skilled in the art, other modifications can be easily implemented. Therefore, without departing from the general concepts limited by the claims and equivalent scopes, the present application is not limited to specific details and the illustrations shown and described herein.

What is claimed is:

1. A quantitative evaluation method for a leakage rate of a salt cavern helium gas storage in a gas injection construction period, comprising the following steps:
S1, acquiring basic data of the salt cavern helium gas storage;
S2, monitoring and recording wellhead pressure, gas injection flow rate, and gas injection temperature data in real time in the gas injection construction period; and
S3, performing numerical simulation on a temperature field of helium gas in the storage, a creep law of a cavity, and a dissolving trend of the helium gas by using the basic data of the salt cavern helium gas storage and the real-time monitored data, to achieve quantitative evaluation of the leakage rate.

2. The quantitative evaluation method for the leakage rate of the salt cavern helium gas storage in the gas injection construction period according to claim 1, wherein in S3, the quantitative evaluation of the helium gas leakage rate comprises calculating a leakage amount of the helium gas; and a calculation method for the leakage amount of the helium gas is:
$${n}_{L} = {n}_{0} - {n}_{k} - {n}_{r} ; \qquad Formula ( 1 )$$
in Formula (1), n_{L} represents the leakage amount of the helium gas; no represents an accumulative injection amount of the helium gas; nᵣ represents a dissolved quantity of the helium gas; and nₖ represents a storage amount of the helium gas in the current cavity.

3. The quantitative evaluation method for the leakage rate of the salt cavern helium gas storage in the gas injection construction period according to claim 2, wherein a calculation method for the storage amount nₖ of the helium gas in the current cavity is:
$${n}_{k} = \int {\int }_{V} \int \frac{p ( V + Δ V )}{{ZRT}_{f}} dV ; \qquad Formula ( 2 )$$
in Formula (2), V represents a volume of a salt cavern cavity; ΔV represents an actually measured volume shrinkage; T_{f} represents a temperature of the helium gas; P represents a pressure of the helium gas; Z represents a compression factor of the helium gas; R represents a gas constant; and
by combining Formula (1) and Formula (2), the helium gas leakage rate is calculated.

4. The quantitative evaluation method for the leakage rate of the salt cavern helium gas storage in the gas injection construction period according to claim 3, wherein in S3, the numerical simulation of the dissolving trend of the helium gas is to predict a dissolved quantity of the helium gas, and diffusion dissolution of the helium gas in brine is obtained according to a diffusion law, which satisfies the following formula:
$$\frac{\partial c}{\partial t} + ∇ \cdot ( - D ∇ c ) = 0 ; \qquad Formula ( 3 )$$
in Formula (3), c represents a concentration of the helium gas in the brine; D represents a diffusion coefficient of the helium gas in the brine;
based on Formula (3), concentration distributions of the helium gas in the brine at different moments can be simulated; and the dissolved quantity nᵣ of the helium gas is calculated by volume integration using the following formula:
$${n}_{r} = \int {\int }_{V} \int cdV . \qquad Formula ( 4 )$$

5. The quantitative evaluation method for the leakage rate of the salt cavern helium gas storage in the gas injection construction period according to claim 4, wherein the creep law of the cavity in S3 is to predict the volume shrinkage of the salt cavern helium gas storage, and a calculation method is:
$${\int }_{0}^{t} {ae}^{- x} dt = \frac{Δ V}{V} ; \qquad Formula ( 5 )$$
in Formula (5), V represents the volume of the salt cavern cavity; ΔV represents the actually measured volume shrinkage; X represents a creep rate attenuation index, which is obtained through a core creep test on a target layer of the helium gas storage; and a represents an empirical coefficient, which is obtained by inverting the actually measured volume shrinkage of the cavity.

6. The quantitative evaluation method for the leakage rate of the salt cavern helium gas storage in the gas injection construction period according to claim 5, wherein in S3, a method for predicting the temperature field of the helium gas is as follows:
$$A ρ {C}_{V , g} \frac{\partial {T}_{f}}{\partial t} - A ( ρ {μ}_{jT} {C}_{V , g} + 1 ) \frac{\partial p}{\partial t} = {Q}_{e} ; \qquad Formula ( 6 )$$
in Formula (6), A represents a cross-sectional area of a wellbore or a salt cavern; ρ represents a density of the helium gas; C_{v,g} represents a specific heat capacity of the helium gas; T_{f} represents the temperature of the helium gas; t represents time; μ_{jT} represents the Joule Thomson coefficient of the helium gas; p represents a pressure of the helium gas; Qₑ represents a convective heat transfer rate between the helium gas and surrounding rock; a calculation method for Qₑ is:
$${Q}_{e} = 2 π {r}_{0} {U}_{we} ( {T}_{e} - {T}_{f} ) ; \qquad Formula ( 7 )$$
in Formula (7), r₀ represents a radius of the wellbore or salt cavern; U_{we} represents a comprehensive heat transfer coefficient between the gas and a surrounding environment; Tₑ represents a formation temperature; a calculation method for Tₑ is:
$${ρ}_{e} {C}_{e} \frac{\partial {T}_{e}}{\partial t} = \frac{1}{r} \frac{\partial }{\partial r} ( {k}_{e} r \frac{\partial {T}_{e}}{\partial r} ) ; \qquad Formula ( 8 )$$
in Formula (8), r represents a distance from a center of the gas storage; ρₑ represents a density of formation rock; Cₑ represents a specific heat capacity of geological rock; Kₑ represents a thermal conductivity coefficient of the formation rock;
a calculation method for the comprehensive heat transfer coefficient U_{we} between the gas and the surrounding environment is:
$${U}_{we}^{- 1} = \frac{1}{{h}_{t}} + \frac{{r}_{to} ln ( {r}_{co} / {r}_{ci} )}{{k}_{cas}} + \frac{{r}_{to} ln ( {r}_{ces} / {r}_{co} )}{{k}_{ces}} ; \qquad Formula ( 9 )$$
in Formula (9), hₜ represents a heat transfer coefficient of the helium gas; rₜₒ, r_{co}, r_{ci}, and r_{ces} represent an outer diameter of an injection and production pipe, inner and outer diameters of a casing, and an outer diameter of a cement sheath, respectively; k_{cas} and k_{ces} are thermal conductivity coefficients of the casing and the cement sheath; and
by combining Formula (6) to Formula (9), temperature changes of the helium gas in the cavity over time in the gas injection construction period are calculated.

7. A quantitative evaluation system for a leakage rate of a salt cavern helium gas storage in a gas injection construction period, comprising:
a basic data acquisition unit, configured to: acquire basic data of the salt cavern helium gas storage;
a real-time monitoring unit, configured to monitor and record wellhead pressure, gas injection flow rate, and gas injection temperature data in real time in the gas injection construction period; and
a leakage rate quantitative evaluation unit, configured to: perform numerical simulation on a temperature field of helium gas in the storage, a creep law of a cavity, and a dissolving trend of the helium gas by using the basic data of the salt cavern helium gas storage and the real-time monitored data, and perform quantitative evaluation on the leakage rate of the salt cavern helium gas storage according to actually measured wellhead pressure data.

8. The quantitative evaluation system for the leakage rate of the salt cavern helium gas storage in the gas injection construction period according to claim 7, wherein the basic data acquired by the basic data acquisition unit is basic data used for quantitative evaluation on the leakage rate of the salt cavern helium gas storage, and comprises sonar cavity data of the salt cavern cavity, a well trajectory, a well bore structure, and a size of a gas injection pipe.

9. The quantitative evaluation system for the leakage rate of the salt cavern helium gas storage in the gas injection construction period according to claim 7, wherein the real-time monitoring unit comprises a gas flow meter, a gas thermometer, and a wellhead pressure gauge which are arranged on a ground injection and production manifold to monitor and store a wellhead pressure, a gas injection flow rate, and a gas injection temperature in real time.

10. The quantitative evaluation system for the leakage rate of the salt cavern helium gas storage in the gas injection construction period according to claim 8, wherein the data monitored and recorded by the real-time monitoring unit is transmitted to a data receiver through Bluetooth, and the actually measured data is transmitted through the data receiver to the leakage rate quantitative evaluation unit for quantitative evaluation of a leakage rate.
